(19) United States
(12) Patent Application Publication
(10) Pub. No.: US 2026/0111454 A1
(43) Pub. Date: Apr. 23, 2026

(54) MAPPING MAC ADDRESS TO PUBLIC CHARGING EVSE USING CONNECTED VEHICLE BIG DATA

(71) Applicant: Ford Global Technologies, LLC, Dearborn, MI (US)

(72) Inventors: Su Yu, Royal Oak, MI (US); Kai Wu, Pittsburgh, PA (US); Venkatarao Rebba, Dearborn, MI (US); Stan Bradbury, Saline, MI (US); Chen Zhang, South Lyon, MI (US)

(21) Appl. No.: 18/918,701

(22) Filed: Oct. 17, 2024

(51) Int. Cl. G06F 16/31; G06Q 30/0226

(52) U.S. Cl. CPC G06F 16/316; G06Q 30/0227

(57) ABSTRACT

Methods and systems are provided for associating Media Access Control (MAC) addresses with public chargers of electric vehicles, also known as Electric Vehicle Supply Equipment (EVSE), using a statistical approach and leveraging big data from connected vehicles (CV) and charge point operators (CPO). The data products generated by the method described herein can be utilized by electric vehicles (EV) to identify the charging EVSE during a public charging event.

### FIELD

The present description relates generally to methods and systems for charging an electric vehicle.

### BACKGROUND/SUMMARY

A plug-in electric vehicle (EV) operates on electricity stored in one or more batteries of the EV. When the stored electricity decreases below a threshold, the one or more batteries may be recharged at a charging station. A charging station may include a plurality of chargers, also referred to herein as Electric Vehicle Supply Equipment (EVSEs). The EV may navigate to a charging station, connect to an EVSE of the charging station, and charge the one or more batteries.

The charging station may offer services to increase an efficiency of charging the EV and/or reducing a time spent charging the EV. One such service is a “Plug & Charge” (P&C) feature, where charging may be initiated without presenting a credit card, app, or other form of payment. Such services rely on the EV establishing a communication with an EVSE of the charging station to which the EV is connected. The communication may rely on a Transport Layer Security (TLS) handshake, wherein the EV and the EVSE execute a series of steps to authenticate each other, agree on encryption standards, and establish a connection.

An alternative “Plug & Activate” (P&A) feature may also be provided, that relies on pairing EVs and EVSEs during charging events using global positioning system (GPS) location data of the EVs at the time of the charging events and medium access control (MAC) addresses assigned to the EVSEs. When an EV connects to an EVSE to receive a charge, the EVSE may send a MAC address to the EV. The EV may send GPS location data of the vehicle and the MAC address to a cloud-based service, which may consult a table of EVSE/MAC address pairings to identify the EVSE. The EVSE may be authenticated based on the EVSE ID, without the use of public key encrypted certificates relied on by P&C. In this context, there is a need for shifting seamlessly between P&A and P&C charging frameworks.

In one example, the issue described above could be at least partially addressed by a method, comprising generating, from charging data collected from a plurality of charging sessions recorded between a plurality of electric vehicles (EVs) and a plurality of chargers (e.g., EVSEs), a set of pairings of IDs of the chargers with medium access control (MAC) addresses of the chargers, the set of ID/MAC address pairings used to authenticate an EV of the plurality of EVs and a charger of the plurality of chargers during a charging session of the EV at the charger; and storing the ID/MAC address pairings in a database in a cloud. The charger ID/MAC address pairings may then be used to authenticate charging sessions of an EV of the plurality of EVs at chargers of the plurality of chargers. For example, during a charging session, the EV may receive a MAC address of a charger. The EV may send the MAC address to a remote authentication system in a cloud, and the remote authentication system may consult the charger ID/MAC address pairings to determine an ID of the charger. The remote authentication system may then authenticate the charging session based on the ID, and send a remote activation request including the ID to a charge point operator (CPO) of the charger so that the vehicle can receive a charge from the charger.

In this way, by leveraging connected vehicle data from a large number of EVs, for example, all EVs managed by a CPO, or all EVs wirelessly connected to the CPO of a geographical region, across a plurality of historical vehicle charging events, a sufficiently large and reliable set of EVSE/MAC address pairings may be generated to support widespread adoption of P&A. The mapping outcomes for each charge session may be aggregated using statistical methods at both of an EVSE level and a connector level, to generate a high-confidence mapping table. The mapping table may be stored in a database in a cloud, and accessed by the remote (e.g., cloud-based) authentication system during charging events. Additionally, robust methods are provided that may be used by the remote authentication system to switch between P&C charging and P&A charging for different EVs and charging sessions, based on efficiency, user preferences, and CPO preferences, to ensure a user-friendly charging experience with minimal human input.

It should be understood that the summary above is provided to introduce in simplified form a selection of concepts that are further described in the detailed description. It is not meant to identify key or essential features of the claimed subject matter, the scope of which is defined by the claims that follow the detailed description. Furthermore, the claimed subject matter is not limited to implementations that solve any disadvantages noted above or in any part of this disclosure.

### BRIEF DESCRIPTION OF THE DRAWINGS

The advantages described herein will be more fully understood by reading an example of an embodiment, referred to herein as the Detailed Description, when taken alone or with reference to the drawings, where:

FIG. 1 shows an exemplary EV charging system;

FIG. 2 shows schematic diagram of an exemplary connection between and exemplary EV and a charging station;

FIG. 3 is a flowchart illustrating an exemplary high-level method for determining a set of mappings between IDs and MAC addresses of a plurality of EVSEs;

FIG. 4 is a flowchart illustrating an exemplary method for using GPS location and timestamp data to map MAC addresses to EVSE IDs;

FIG. 5 is a flowchart illustrating an exemplary method for performing an EVSE-level analysis of a set of EVSE/MAC address pairings;

FIG. 6 is a flowchart illustrating an exemplary method for performing a connector-level analysis of an EVSE/MAC address pairing;

FIG. 7 is a flowchart illustrating an exemplary method for an EV for receiving a charge at a charging station;

FIG. 8 is a flowchart illustrating an exemplary method for authenticating an EV at a charging station for receiving a charge using a P&A framework; and

FIG. 9 is a flowchart illustrating an exemplary method for remote activation of an EV when the EV is not authenticated via either of the P&A framework and a P&C framework.

### DETAILED DESCRIPTION

Systems and methods are provided for managing the charging of an electric vehicle (EV) within an electric vehicle charging system. An electric vehicle charging system may be defined as a system that charges a battery mounted in the electric vehicle using electric power acquired from a commercial power grid or an energy storage device. The electric vehicle charging system may include the EV and an electric vehicle supply equipment (EVSE), and may be categorized into a conductive charging system and a wireless power transfer system.

A charging station equipped with the EVSE may start the charging after an authentication process for the EV and/or the EV user. The authentication process may depend on a charging infrastructure and capabilities of the EV. One typical authentication scheme for charging the EV is a Plug & Charge (P&C) scheme, in which the authentication and payment are automatically performed using a contract certificate stored in the EV. Another authentication scheme for charging the EV may use external identification means (EIM) such as a credit card, a debit card, cash, and/or a smartphone application for an identification and authentication of the user and a payment of charging fee.

In the case of conductive charging, the P&C scheme refers to a plug-and-charge scheme by which the authentication and the EV charging are performed automatically by simply plugging a conductor extending from the charging station to the EV. In the case of wireless power transfer, the P&C scheme refers to a park-and-charge scheme by which the authentication and the EV charging are performed automatically by simply parking the EV on a charging spot of a charging station. The P&C scheme enables all processes such as the EV user authentication, charging, and billing to be performed automatically during a charging session. Conventionally, an EV owner who wishes to use a P&C service has to conclude a service contract with a mobility operator (MO) before or after the EV is handed over from a manufacturer to the owner. After concluding the contract, a contract certificate is installed in the EV when the EV is charged for the first time. Afterwards, the EV owner may receive the P&C service from charging stations associated with the MO. Various additional P&C services for the EV may also be provided, such as an EV diagnosis, a firmware update, and a certificate update.

A conventional P&C authentication procedure is performed through communication with transport layer security (TLS) and uses a digital signature based on a public key infrastructure (PKI). All entities associated with the charging and the authentication have to acquire and retain certificates, and systems for issuing and managing these certificates may have to be added in the P&C infrastructure. The conventional P&C authentication procedure uses PKIs, including a MO PKI, a CPO PKI, and an original equipment manufacturer (OEM) PKI, which may rely on a complex backend system. Use cases for a vehicle sharing and an EV ownership assignment may not be supported, and a certificate provisioning service and a directory service for the authentication and authorization procedure may rely on centralized trusts.

To broaden options for charging the EV, and in particular, increasing an efficiency of identifying and authenticating an EVSE used to charge a vehicle, an alternative communication method referred to as “Plug & Activate” (P&A) has been proposed, where Media Access Control (MAC) addresses are used to identify public chargers (EVSEs) for authentication. However, the P&A framework relies on having a set of mappings of EVSE IDs to EVSE MAC addresses, which may be stored in a cloud and accessed by an EV during a charging session. Because current methods of generating and maintaining the set of mappings may be slow, inefficient, and inaccurate, a statistical approach to generating the mappings is proposed herein, based on leveraging big data from connected vehicles and the CPOs. Data products generated by the methods described herein, such as a table that maps EVSE IDs to EVSE MAC addresses, can be utilized by EVs to identify a charging EVSE during a public charging event, thereby reducing or eliminating the use of the public key infrastructure relied on by P&C, and facilitating increased individual EVSE reliability metrics. Additionally, an integrated approach is proposed that combines the functionalities of P&A and P&C to cover a wide range of use cases.

The P&A framework based on establishing EV-EVSE communication through EVSE-MAC address mapping offers several advantages. Firstly, analogous to P&C, it enables vehicle operators to connect to an EVSE and initiate charging and billing automatically, without having to use a credit card or other payment method. This benefit applies to any direct current fast charger (DCFC), provided that the Charge Point Operator (CPO) does not intentionally randomize their MAC addresses, regardless of whether the EVSE supports the relevant P&C standard. Secondly, this communication method can monitor maintenance demands, power disruptions, and derated charging for each EVSE, thereby allowing cloud-based systems to assess the reliability and performance of each EVSE of a charging station, and/or guide users to an EVSE with a higher performance in future visits. Finally, such communication may also enhance other advanced EV-EVSE interactions that are under development for future digital products. Such benefits of P&A may depend on having a database of accurate and reliable EVSE/MAC address pairings that provides sufficient coverage of a total population of EVSEs of the CPO, which may be generated using the methods and systems disclosed herein.

Note that although the discussion herein is described with respect to electric vehicles, the embodiments described herein are applicable to any form of plug-in vehicle, such as battery powered vehicles or hybrid vehicles, that are recharged by plugging into an electric grid.

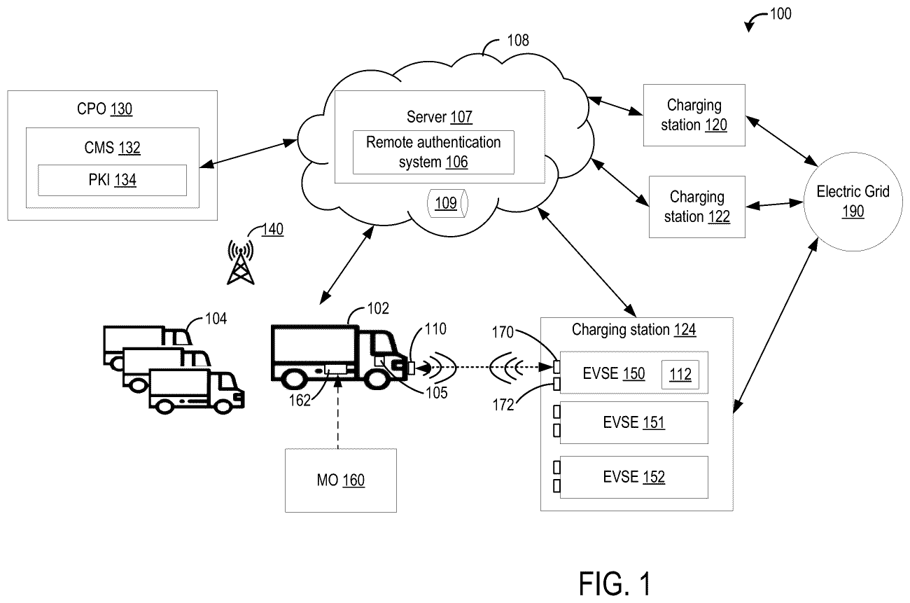

FIG. 1 shows an electric vehicle charging system 100, including an EV 102, a plurality of charging stations 120, 122, and 124. EV 102 may be a plugin hybrid vehicle, a range-extended hybrid vehicle, an electric traction or battery or plugin vehicle, or a different type of electric vehicle. EV 102 may be a car, light or heavy truck, bus, or any other type of vehicle operated on roadways and charged via an electric charging station. In some embodiments, EV 102 may be owned and operated by a user (e.g., a driver). In other embodiments, EV 102 may be owned by a first party and operated by a second party. In various embodiments, EV 102 may be owned by a company and operated by an employee of the company. For example, EV 102 may be one of a plurality of EVs of a vehicle fleet 104, where vehicle fleet 104 is managed by the company (e.g., rental cars, delivery vehicles, busses, etc.).

Charging stations 120, 122, and 124 may be installed at a public (e.g., non-networked) or private (e.g., networked) charging station. Charging stations 120, 122, and 124 may be connected to an electric grid 190, which may receive power from a utility company.

EV 102 and charging stations 120, 122, and 124 may be wirelessly connected to a cloud 108 via a wireless network 140. Wireless network 140 may include the Internet. As such, EV 102 may communicably couple to one or more of charging stations 120, 122, and 124. A CPO 130 may manage charging stations 120, 122, and 124 using a Charging Management System (CMS) 132, via wireless network 140. Data acquired by charging stations 120, 122, and 124 may be transmitted to CMS 132 via wireless network 140 and cloud 108, and data may be transmitted from CMS 132 to charging stations 120, 122, and 124.

During the charge event, EV 102 may be coupled to a selected charging station 124. Charging station 124 (and charging stations 120 and 121) may include a plurality of EVSEs (e.g., chargers) to which EV 102 may couple, such as an EVSE 150, an EVSE 151, and an EVSE 152. One or more of EVSEs 150, 151, and 152 may be a DCFC. To receive a charge, EV 102 may park within a threshold proximity of a selected EVSE 150, and power may be transferred from selected EVSE 150 to EV 102 wirelessly, via a wireless power transfer interface between EVSE 150 and EV 102.

During charging, EV 102 may exchange information of the charge event (e.g., battery charging parameters, charging data and feedback, vehicle system data) with charging station 124 via the wireless connection. In some embodiments, EV 102 may additionally or alternatively communicate and/or exchange information with selected charging station 124 via radio frequency (RF) signals. For example, EV 102 may include a first RF transceiver 110, and charging station 124 may include a second RF transceiver 112, where information of EV 102 may be sent from first RF transceiver 110 to second RF transceiver 112, and/or information of selected charging station 124 may be sent from second RF transceiver 112 to first RF transceiver 110. For example, the information may be exchanged via a wireless electronic device interconnector, such as a Bluetooth® connection.

Each of EVSE 150, 151, and 152 may include one or more connectors, through which a charge may be delivered from a respective EVSE to a connected EV. For example, EVSE 150 includes a first connector 170 and a second connector 172. EV 102 is depicted as coupling to EVSE 150 via first connector 170. A second EV may couple to EVSE 150 via second connector 172, and as EV 102 receives a first charge from EVSE 150, the second EV may concurrently receive a charge from EVSE 150 through second connector 172.

During a charge event, EV 102 may receive a wireless charge from first connector 170 of selected EVSE 150 under a P&C scheme, where processes such as the EV user authentication, charging, and billing may be performed automatically during a charging session, meaning, without intervention by a driver of EV 102. Some of the processes may be performed at a cloud-based server 107 of cloud 108, such as by a remote authentication system 106 running on the cloud-based server. Other processes may be performed by a controller 105 of EV 102, and still other processes may be performed by a processor of EVSE 150.

Under the P&C scheme, to authenticate EV 102, a TLS communication between EV 102 and EVSE 150 may be performed based on a digital signature of EV 102 in a PKI certificate 162 stored at EV 102, where PKI certificate 162 is issued by an MO 160. During the TLS communication, PKI certificate 162 may be verified during a P&C authentication procedure, as well as a PKI certificate 134 of CPO 130, and other PKI certificates. Each of the PKI certificates included in the authentication procedure may be separately generated an issued by a respective entity. As a result of the complexity of maintaining the PKI certificates 162, 134, and the other PKI certificates, the conventional P&C authentication procedure may be complicated and may result in incomplete or invalid authentications.

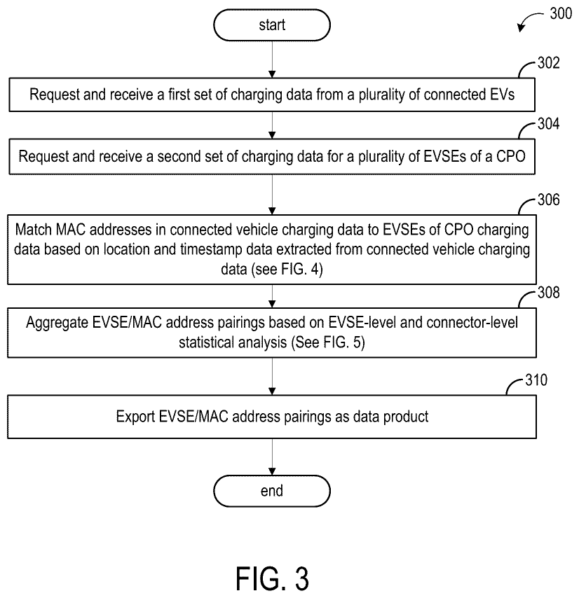

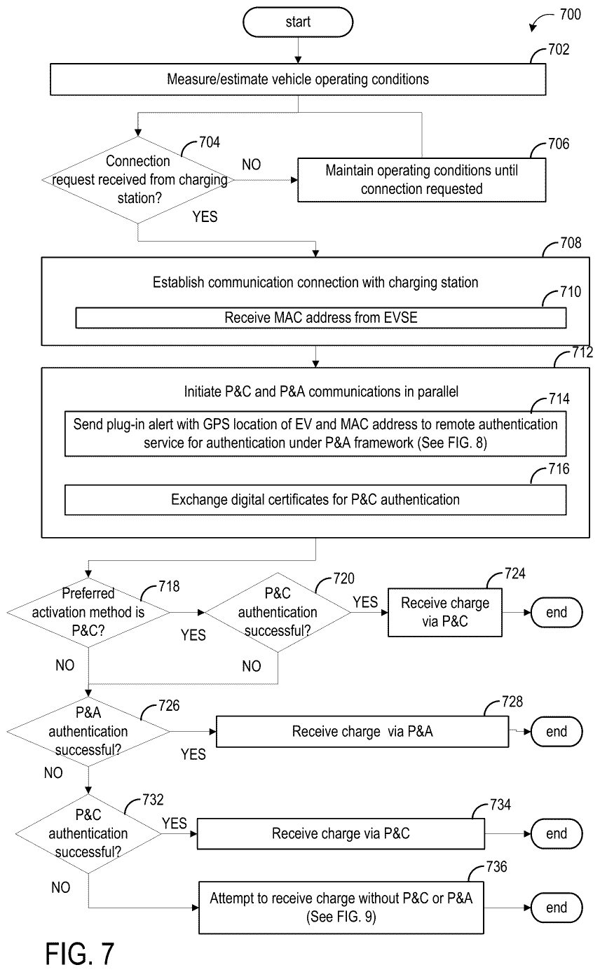

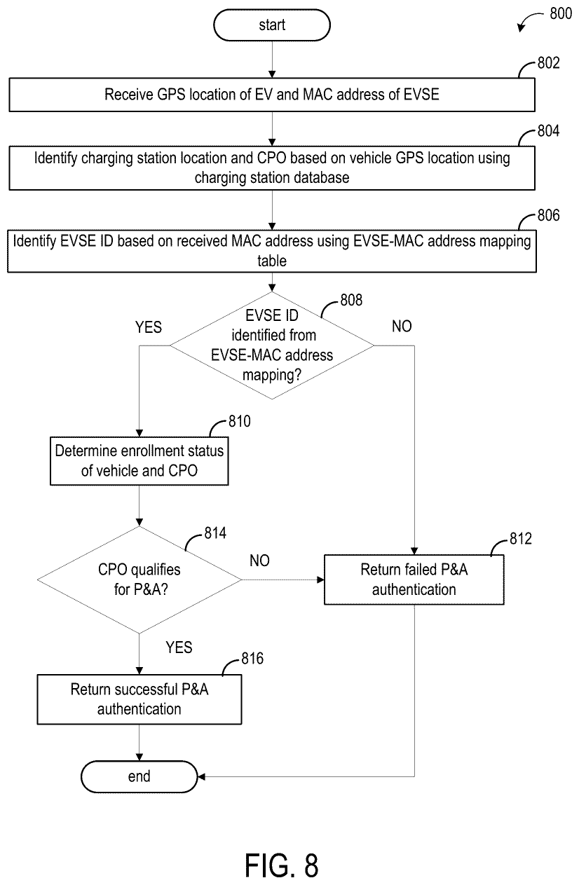

To reduce the complexity of the P&C authentication process, an alternative P&A authentication procedure may be used, which may be performed between EV 102 and EVSE 150. During the P&A authentication procedure, EV 102 may authenticate EVSE 150 by transmitting a MAC address received from EVSE 150 to cloud-based server 107. At cloud-based server 107, the MAC address may be matched with EVSE 150, by consulting a database 109 of previously generated EVSE/MAC address pairings. The EVSE/MAC address pairings may be generated, regenerated, and/or updated using the methods described in reference to FIGS. 3-8. In some examples, the EVSE/MAC address pairings may be regenerated regularly, such as daily. EV 102 may then authenticate EVSE 150, and vice-versa, based on an EVSE ID retrieved from database 109 and sent to EV 102 by cloud-based server 107. Methods for performing the proposed authentication procedure are described below in reference to FIGS. 7 and 8.

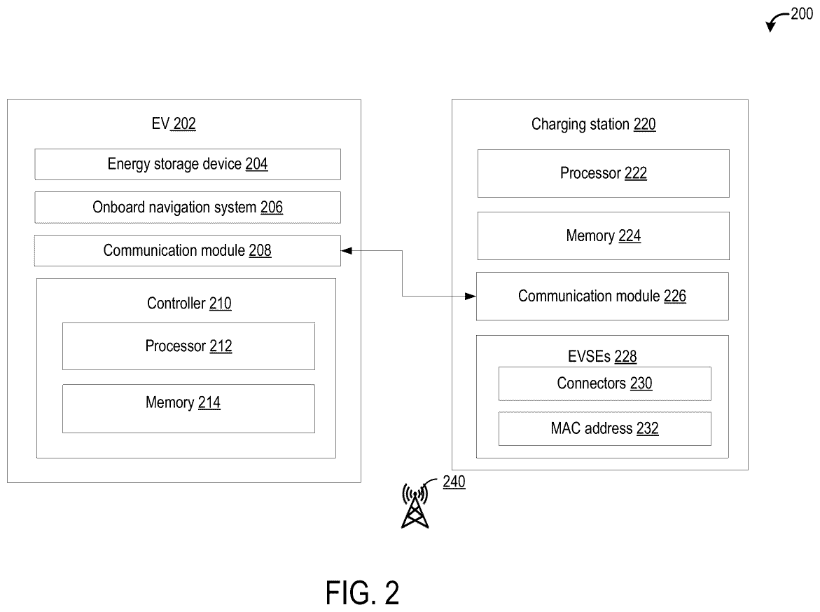

Referring now to FIG. 2, a schematic diagram 200 shows an EV 202 in communication with a charging station 220, which may be non-limiting examples of EV 102 and charging station 124, respectively, of the electric vehicle charging system 100 of FIG. 1.

Charging station 220 includes at least a processor 222, a memory 224, a communication module 226, and a plurality of EVSEs 228 (e.g., EVSEs 150-152 of FIG. 1), which may be DCFCs. Each EVSE 228 may include one or more connectors 230. Each connector 230 may be used to connect a respective EVSE 228 to an EV, such that the EV can receive a charge from the EVSE 228 via the respective connector 230. Each EVSE 228 may also have an assigned MAC address 232, which may be used to identify an EVSE 228, as described in greater detail below.

As described herein, a memory (such as memory 224) may include one or more data storage structures, such as optical memory devices, magnetic memory devices, or solid-state memory devices, for storing programs and routines executed by a processor (e.g., processor 222) to carry out various functionalities disclosed herein. Memory may include any desired type of volatile and/or non-volatile memory such as, for example, static random access memory (SRAM), dynamic random access memory (DRAM), flash memory, read-only memory (ROM), etc. Processor 222, as well as other processors described herein, may be any suitable processor, processing unit, or microprocessor, or a multi-processor system including one or more additional processors that are identical or similar to each other and that are communicatively coupled via an interconnection bus.

Communication module 226 may control a communication between charging station 220 and one or more EVs that receive a charge at charging station 220, such as EV 202. The communication may include wired communication, for example, via a cable communicatively coupling EV 202 with charging station 220, or the communication may include wireless communication, for example, via a wireless network 240 (e.g., wireless network 140) using a modem, or via a radio frequency (RF) transceiver. In some examples, EV 202 may communicate with charging station 220 (for example, during a charge event) via Bluetooth®, or via a different RF protocol. Communication via communication module 226 may be implemented using one or more protocols. Communication module 226 can include a wired interface (e.g., a data bus, a Universal Serial Bus (USB) connection, etc.) and/or a wireless interface (e.g., radio frequency, infrared, near field communication (NFC), etc.). For example, the communication module may communicate via wired local area network (LAN), wireless LAN, wide area network (WAN), etc. using any past, present, or future communication protocol (e.g., BLUETOOTH™, USB 2.0, USB 3.0, etc.).

Additionally, communication module 226 may be configured to encrypt communications transmitted from EV 202 to charging station 220, and decrypt communications received at EV 202 from transmitters including charging station 220. In other words, communication module 226 may establish a secure connection with EV 202; subsequently transmit information from charging station 220 to EV 202 via the secure connection; and receive information at charging station 220 from EV 202 via the secure connection. The information exchanged between EV 202 and charging station 220 may include identification information of EV 202, identification information of an EVSE 228 to which EV 202 is coupled to and/or receives a charge from; information about a charging session of EV 202, such as starting time, and end time, and a duration of the charging session; and other data. By sending and receiving encrypted communications via the secure anonymous connection, a privacy of data of EV 202, a driver of EV 202, and/or an owner of EV 202 may be protected. For example, the data may include proprietary information about the owner or driver, a location or route of the driver, historical driving habits of the driver, information about a fleet of EVs owned and managed by the owner, a participation of the owner in one or more incentive programs, and other data, which if unencrypted could be used by a malicious third party interceptor to achieve various improper marketing, business, or other goals.

EV 202 includes at least one energy storage device 204, such as a traction battery, that stores electricity used to propel wheels of EV 202. The electricity may be received by energy storage device 204 when EV 202 is charged, for example, at charging station 220, or when plugged into an electric grid (e.g., electric grid 190) via a power outlet such as at a home of a driver of EV 202. In some embodiments, energy storage device 204 may include an energy storage device controller, which may provide charge balancing between various storage elements (e.g., battery cells) of energy storage device 204 and communication with other vehicle controllers. A flow of power into and out of electric energy storage device 204 may also be controlled by the energy storage device controller, or by a power distribution module of the energy storage device controller of energy storage device 204.

EV 202 may include an onboard navigation system 206. Onboard navigation system 206 may provide route information to the driver of EV 202, including a current location of EV 202 and a destination of EV 202. For example, when operating EV 202, the driver may enter a destination into onboard navigation system 206. Onboard navigation system 206 may indicate one or more routes from the current location to the destination on a map displayed by onboard navigation system 206. In various embodiments, the map may be displayed on a screen of a display of onboard navigation system 206, such as a dashboard display. In particular, onboard navigation system 206 may be used to navigate EV 202 to charging station 220. The driver may select a route of the one or more routes to charging station 220, and onboard navigation system 206 may provide instructions to the driver and/or indicate a progress of EV towards charging station 220 on the map. Onboard navigation system 206 may indicate when EV 202 arrives at charging station 220. Thus, onboard navigation system 206 may be used to identify charging station 220 as a station at which EV 202 is receiving a charge and/or differentiate charging station 220 from other charging stations available to EV 202 for recharging.

In some embodiments, onboard navigation system 206 may not be included in EV 202, and onboard navigation system 206 may be an independent navigation system communicably coupled to EV 202. For example, onboard navigation system 206 may be an application (e.g., such as Google Maps) installed on a mobile device communicably coupled to EV 202. The independent navigation system may be linked to one or more displays of EV 202, where route information is displayed on the one or more displays, and/or the route information may be displayed on the mobile device (e.g., in a user interface of the application).

EV 202 may include a communication module 208, which may control a communication between EV 202 and external elements of infrastructure. The external elements of infrastructure may include one or more charging stations, such as charging station 220. Communication module 208 may establish a secure connection with communication module 226, transmit data from EV 202 to charging station 220, and receive data from charging station 220.

EV 202 may include a controller 210. Controller 210 may include one or more processors 212 and a memory 214. Memory 214 may include records of a plurality of historical charging events or sessions of EV 202 with a plurality of charging stations and EVSEs. Controller 210 may authenticate EV 202 and/or an EVSE 228 that EV 202 is connected to, by following the methods described below in reference to FIGS. 7 and 8. In particular, the authentication of EV 202 and/or the EVSE 228 performed by controller 210 may rely on identifying the EVSE 228, which may be performed using a mapping table that maps a MAC address 232 of the EVSE 228 to an ID of the EVSE 228. When EV 202 is charged at an EVSE 228 operated by a CMS, it receives a MAC address for the EVSE during a Signal Level Attenuation Characterization (SLAC)—a communication sequence in which the EVSE signals its presence to the vehicle and vice versa. However, the MAC address is not linked to a specific public EVSE that activates the charger via a remote start request sent to the CMS. Thus, communication for public charging under the P&A approach proposed herein can be facilitated by providing a mapping between the MAC address and the EVSE to support EV-EVSE communication during the authentication procedure.

In some embodiments, the mapping table may be stored at EV 202, in memory 214. Additionally or alternatively, the mapping table may be periodically or regularly regenerated and stored, for example, at a cloud-based database, such as database 109 of cloud 108 of FIG. 1. When a charge event is initiated between EV 202 and the EVSE 228, controller 210 may request the mapping table from a cloud-based remote authentication system (e.g., remote authentication system 106 of FIG. 1), or may request the MAC address-ID mapping for the EVSE 228 from the remote authentication system, and the remote authentication system may look up the mapping in the stored mapping table. After the EVSE ID has been obtained, an authentication procedure may be performed, such as the authentication procedure described in reference to FIG. 8 below.

Turning now to FIG. 3, a method 300 is shown for generating a table of ESVE ID/MAC address pairings for a plurality of EVSEs, such as the ESVEs 228. Method 300 may be performed by a processor of a cloud-based server, such as cloud-based server 107 of cloud 108 of FIG. 1. In some examples, the cloud-based server may include a remote authentication system, and method 300 may be performed by the remote authentication system. Method 300 may also be performed by a processor of a different component of a charging system such as charging system 100. For example, method 300 could alternatively be performed at an EV, such as EV 102, or at server of CPO 130.

At 302, method 300 includes requesting and receiving a first set of charging data of a plurality of connected EVs. The plurality of connected EVs may include, for example, all EVs managed by a CPO (e.g., CPO 130), or all EVs operating in a geographic region of interest of the CPO. The plurality of connected EVs may include all EVs receiving over-the-air (OTA) updates from a manufacturer of the EVs. The first set of charging data may be requested and received wirelessly by the cloud-based server, for example, via a wireless communication module (e.g., communication module 208) of each EV of the plurality of connected EVs.

Each vehicle capable of sending connected vehicle data may be equipped with a device called the Enhanced Central Gateway (ECG). In various examples, the ECG acts as a central data handler and serves as a hub of a vehicle network. The ECG can extract necessary CAN bus and other signals, compile them, and send them to a Transportation Mobility Cloud (TMC). The TMC is a cloud infrastructure for all transportation mobility solutions, including the person, vehicle, curb, street, and city. In general, the ECG includes scripts and logic to trigger the collection and transmission of certain messages at specific frequencies.

The first set of charging data may include records of a plurality of historical charging events or sessions with a plurality of charging stations (e.g., charging stations 120, 122, 124) and EVSEs managed by a CMS of the CPO (e.g., CMS 132). Among other things, the first set of charging data may include, for each charging session of each EV of the plurality of connected EVs, at least a GPS location of the EV during the charging session, as obtained from an onboard navigation system of the respective vehicle (e.g., onboard navigation system 206); a MAC address of the EVSE used to charge the vehicle during the charging session, as received by the EV; a starting timestamp of the charging session as received by the EV; and an ending timestamp of the charging session as received by the EV.

At 304, method 300 includes requesting and receiving, from the CPO, a second set of charging data of the plurality of charging stations and EVSEs. The second set of charging data may include historical charging records of the EVSEs, where each charging station of the plurality of charging stations may include a plurality of EVSEs. The second set of CPO charging data may include, for each charging session of each ESVE, an ID of the ESVE; an ID of a connector of the EVSE used during the charging session; an ID and a GPS location of the charging station; a starting timestamp of the charging session as received by the EVSE; and an ending timestamp of the charging session as received by the EVSE.

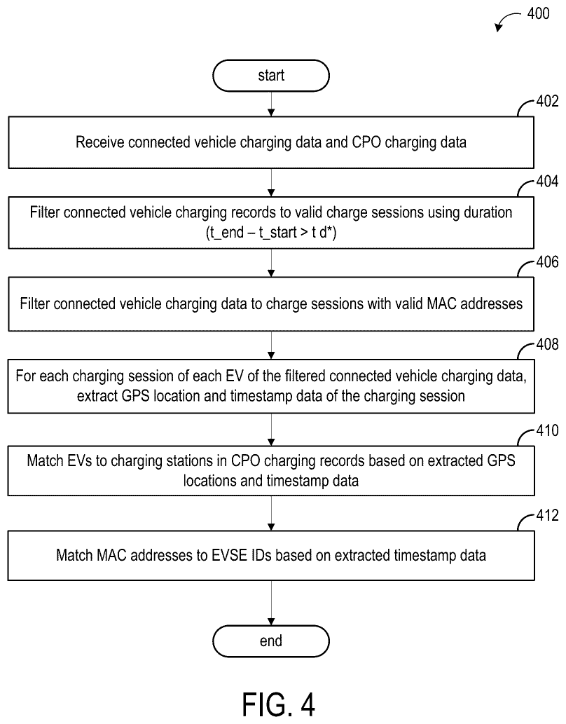

At 306, method 300 includes matching MAC addresses of EVSEs included in the connected vehicle charging data (e.g., the first set of charging data) to EVSEs of the CPO charging data (e.g., the second set of charging data), based on based on location and timestamp data extracted from the connected vehicle charging data. In a first step, charging sessions of the first set of charging data of the EVs are matched with charging stations of the second set of charging data of the EVSEs, based on location and timestamp data. GPS data may be accurate enough to identify charging stations, which are usually hundreds of yards apart, but may not be accurate enough to identify EVSEs, which are usually a few feet apart. In a second, EVSE-level mapping stage, the starting/ending timestamps may be matched with CPO charging data to determine the specific EVSE used to charge the vehicle. Matching the EVs of the connected vehicle charging data to EVSEs of the CPO charging data is described in greater detail in reference to FIG. 4.

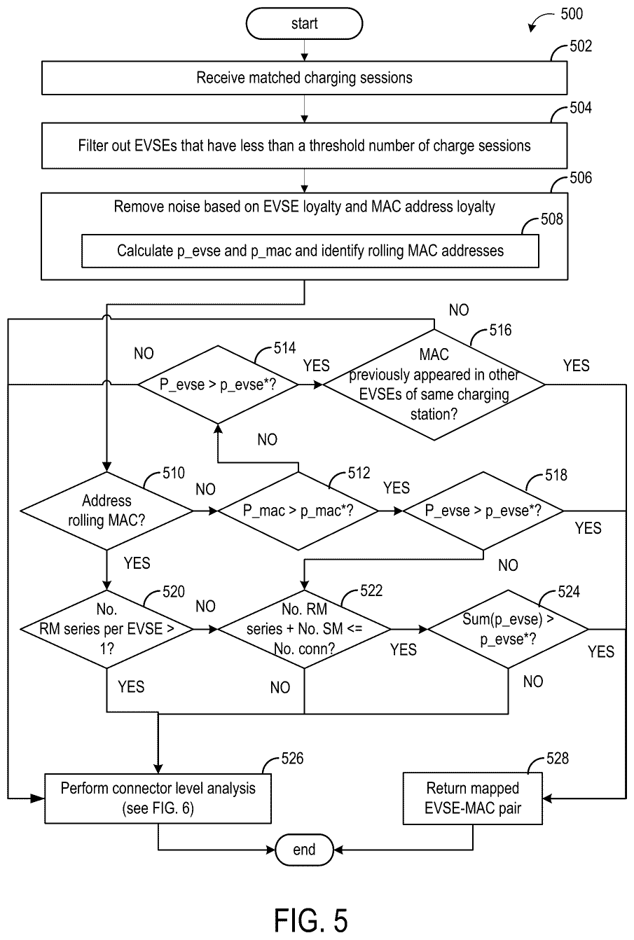

At 308, method 300 includes aggregating the EVSE/MAC address pairings based on an EVSE-level statistical analysis to generate a high-confidence mapping table. Using statistical methods, the algorithm filters out noise in EVSE-MAC address pairs, and identifies special EVSE-MAC scenarios including rolling MAC addresses and onsite transfers of MAC addresses. The EVSE-level statistical analysis is described in greater detail below in reference to FIG. 5.

At 310, method 300 includes exporting the ESVE ID/MAC address pairings as a data product, which may be stored and/or made accessible to the plurality of EVs of the connected vehicle charging data. In various embodiments, the data product may be a mapping table that may indicate, for each MAC address associated with an ESVE, a corresponding ID of the ESVE, and vice-versa. Thus, the mapping table may be used by an EV of the plurality of EVs during a future charging event to retrieve an ID of an EVSE providing a charge to the EV, based on a MAC address of the EVSE received at the EV. The ID may be used to authenticate the EV/ESVE connection to initiate the charging event.

FIG. 4 shows an exemplary method 400 for matching a plurality of MAC addresses of EVSEs included in connected vehicle charging data, to a plurality of EVSEs of CPO charging data, based on based on location and timestamp data extracted from the connected vehicle charging data. In various embodiments, method 400 may be performed as part of method 300 described above in reference to FIG. 3.

Method 400 begins at 402, where method 400 includes receiving connected vehicle charging session data and CPO charging session data, the first and second sets, respectively, of charging data described above.

At 404, method 400 includes filtering the connected vehicle charging data to remove charging sessions that have a duration that is less than a predefined threshold duration, to assure a quality of charging records. In other words, charging sessions with very short time spans may be incomplete or invalid charging sessions. Invalid charging sessions with a duration that exceeds the threshold duration may be selectively eliminated using the following equation 1:

$$duration = {t}_{end , vehicle} - {t}_{start , vehicle} > {t}_{d}^{*} \qquad ( 1 )$$

### Here

$${t}_{d}^{*}$$

is a user-defined duration threshold to filter out short charging events, which may result in issues. Additionally, at 406, method 400 includes filtering the connected vehicle charging data to remove charging sessions with invalid MAC addresses. This excludes MAC addresses such as 00:00:00:00:00:00 and null values that may be erroneously assigned to the EV.

At 408, method 400 includes extracting from the connected vehicle charging data, for each charging session of each EV of the filtered connected vehicle charging data, GPS location data and starting/ending timestamp data of the charging session.

At 410, method 400 includes matching the charging sessions of the CPO charging data with charging sessions of the filtered connected vehicle charging data, based on a distance between a first location of each respective EV during a charging session, and a second location of each charging station during the charging session. The first location is determined by the GPS location data of the EV, and the second location is determined from GPS data of the charging station. This distance should be below a user-defined threshold, D*, which can be fine-tuned based on charging station density and GPS signal accuracy. For example if the charging station density is high, or the GPS signal accuracy is low, D* may be increased to allow a greater cushion for a match; if the charging station density is low, or the GPS signal accuracy is high, D* may be decreased to obtain a more precise match.

Matching the CPO charging records with the filtered connected vehicle charging records may be performed for each EV of the connected vehicle records and each charging station of the CPO charging records, using the following equation 2:

$$distance ( {GPS}_{v e h i c l e} , GP {S}_{station} ) < {D}^{*} \qquad ( 2 )$$

Here, the GPS location of the charging station may be used instead of a GPS location of a specific EVSE, because (a) EVSE level GPS may not be available at most charge stations; (b) a GPS signal may not be accurate enough to pair a vehicle to an EVSE, where a neighboring EVSE may be a few yards away. For example, an EV may be parked in one spot, but be able to receive a charge from two different EVSEs. As such, GPS data may not be reliable enough to identify the EVSE.

At 412, method 400 includes matching MAC addresses of the EVSEs of the charging stations of the COP charging data to EVSE IDs. Due to data quality and signal delays, the start/end timestamps from the EVs and EVSEs may not match exactly, but within a user-defined threshold, Δt*, in accordance with the following equations 3 and 4:

$$Δ {t}_{start} = \vert {t}_{start , vehicle} - {t}_{start , EVSE} \vert < Δ {t}^{*} \qquad ( 3 )$$

$$Δ {t}_{e n d} = \vert {t}_{e n d , v e h i c l e} - {t}_{end , EVSE} \vert < Δ {t}^{*} \qquad ( 4 )$$

In this way, charging sessions in which an EV and an EVSE both participate can be determined first using GPS data, and second, by comparing the starting and ending times of charging session data stored at the vehicle vs. at the EVSE. When the charging session is matched, the MAC address received by the EV from the EVSE can be paired with the ID of the EVSE. Note that this matching process can result in a charging record from the connected vehicle charging data being matched to multiple records of the CPO charging data, such as two cars charging at two EVSEs at the same time at the same charging station. Falsely matched charging sessions are considered noise in this process, and their effects may be mitigated using statistical methods, as described below in reference to FIG. 5.

Referring now to FIG. 5, an exemplary method 500 is shown for performing an ESVE level analysis of a set of pairings of MAC addresses included in the connected vehicle charging data that are paired with EVSE IDs stored in corresponding CPO charging data. Method 500 may be performed by a cloud-based server operated by a CPO, for example.

Method 500 starts at 502, where method 500 includes receiving a plurality of matched charging sessions obtained using method 400 described above. Performing the EVSE level analysis first includes filtering out outliers in the charging session data, where at 504, method 500 includes filtering the plurality of matched charging sessions to remove EVSEs that have less than a threshold number of charging sessions.

At 506, method 500 includes removing noise. Falsely paired EVSE-MAC addresses, referred to herein as noise, may inevitably be included from the matching process described above due to spoofing and data quality issues. The effects of falsely paired EVSE-MAC addresses can be mitigated by checking several statistical parameters when mapping. At the EVSE level, two parameters are evaluated, referred to herein as EVSE loyalty and MAC address loyalty.

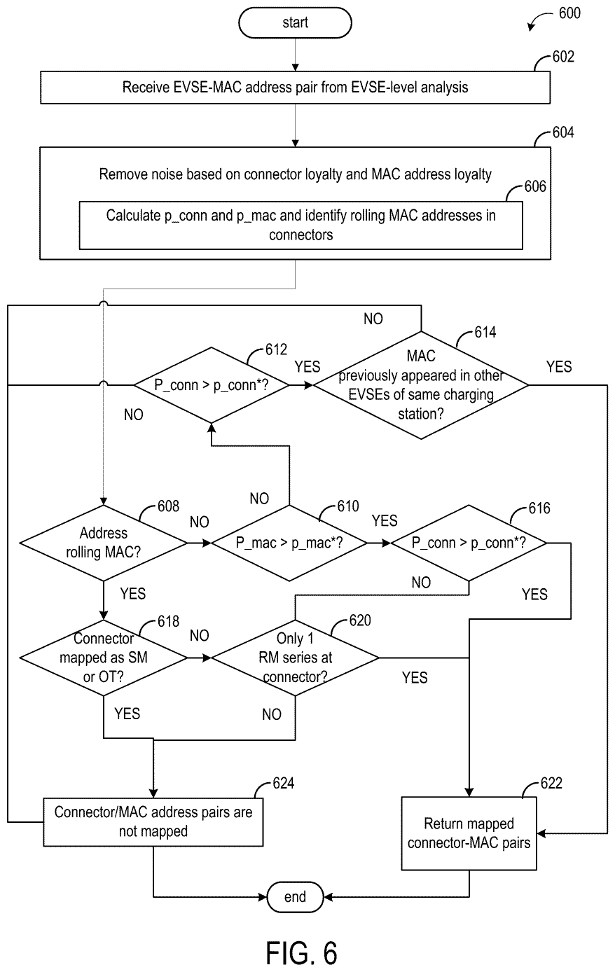

At 508, removing the noise includes calculating EVSE loyalty and MAC address loyalty for each EVSE-MAC address pair of a matched charging session, and identifying whether the EVSE-MAC address pair is a rolling MAC address. Thus, steps 510-528 of method 500 may be performed for each EVSE-MAC address pair of each matched charging session. As a result of performing steps 510-528, the EVSE-MAC address pair is either returned as a valid EVSE-MAC address pair, or a connector-level analysis of the EVSE-MAC address pair is performed, which is described in reference to FIG. 6.

EVSE loyalty is defined as a number between 0 and 1 corresponding to a ratio of a number of charging sessions of an EVSE-MAC address combination to the total number of charging sessions of an EVSE. This parameter may be greater than a user defined threshold,

$${p}_{e vse}^{*} ,$$

such that the mapped MAC address represents a majority of the charging sessions at an EVSE, assuming the mapped MAC address is not subject to rolling MAC address, which is dealt with below. The EVSE loyalty parameter pₑᵥₛₑ may be calculated in accordance with equation 5 below:

$${p}_{e v s e} = \frac{{CS}_{e v se , mac}}{{CS}_{e v s e}} > {p}_{e v s e}^{*} \qquad ( 5 )$$

When an EVSE contains more than one connector, the EVSE may include a plurality of MAC addresses (e.g., one MAC address for each connector). As a result, none of the MAC addresses may satisfy the above threshold

$${p}_{e v s e}^{*} .$$

In such cases, the threshold

$${p}_{e v s e}^{*}$$

may be modified in accordance with equation 6 to check up to n_{conn} MAC addresses, where n_{conn} is the number of connectors of the EVSE.

$${p}_{evse} = {\sum }_{i = 1}^{{n}_{c o n n}} \frac{{CS}_{e v se , {mac}_{i}}}{{CS}_{e v s e}} > {p}_{e v s e}^{*} \qquad ( 6 )$$

Similarly, MAC address loyalty is defined as a number between 0 and 1 corresponding to a ratio of the number of charging sessions of an EVSE-MAC address combination to a total number of charging sessions of a MAC address at a charge station. This parameter may be greater than a user defined threshold,

$${p}_{mac}^{*} ,$$

such that the mapped MAC address at an EVSE represents a majority of the charging sessions within the charging station including this MAC address, assuming the mapped MAC address is not subject to Rolling MAC address or an onsite transfer, which is described below. The MAC address loyalty parameter p_{mac} may be calculated in accordance with equation 7 below:

$${p}_{m a c} = \frac{{CS}_{e v se , mac}}{{CS}_{station , mac}} > {p}_{m a c}^{*} \qquad ( 7 )$$

At 510, method 500 includes determining, for each EVSE/MAC address pair, whether the MAC address is a rolling MAC address. MAC addresses may not be constant. In some cases when an EVSE has experienced a hardware update, a default MAC address of the EVSE may be changed, referred to herein as a rolling MAC address. In contrast, a constant EVSE-MAC address pair is may be referred to as a stationary MAC address. Assuming the new MAC address of the updated hardware is unknown, a rolling MAC address can be identified using a pure data approach by identifying several consecutive charging sessions with one new MAC address. Here, the minimum charging session threshold to identify a rolling MAC address is defined as

$$min {CS}_{r o l l i n g}^{*} .$$

The exact value of

$$min {CS}_{r o l l i n g}^{*}$$

can be tuned by the user to balance a trade-off between identification time and mapping stability. If at 510 it is determined that the EVSE/MAC address pair is not a rolling MAC address, method 500 proceeds to 512.

At 512, method 500 includes determining, for the EVSE/MAC address pair, whether

$${p}_{m a c} > {p}_{m a c}^{*} .$$

If at 512 it is determined that

$${p}_{m a c} \leq {p}_{m a c}^{*}$$

(e.g., the answer is NO), method 500 proceeds to 514. At 514, method 500 includes determining whether

$${p}_{e v s e} > {p}_{e v s e}^{*} .$$

If at 514 it is determined that

$${p}_{e v s e} \leq {p}_{e vse}^{*} ,$$

(e.g., the answer is NO), method 500 proceeds to 526, where method 500 includes performing a connector-level analysis of the EVSE/MAC address pair, described in FIG. 6. Thus, if the EVSE loyalty and the MAC address loyalty are both above their respective threshold values, it may be inferred that the EVSE/MAC address pair is a valid pair. If both EVSE loyalty and MAC address loyalty are below their respective thresholds, the connector-level analysis is performed to determine whether multiple MAC addresses may correspond to multiple connectors of the relevant EVSE.

If at 514 it is determined that

$${p}_{e v s e} > {p}_{e v s e}^{*} ,$$

(e.g., the answer is YES), method 500 proceeds to 516. At 516, method 500 includes determining whether the MAC address has previously appeared in other EVSEs of the same charging station. This may occur as a result of an online transfer, a special case observed from MAC address mapping when a MAC address is transferred to another new EVSE at a same charging station with no prior charging history. (A MAC address transferred to another EVSE with prior charging history will be considered a rolling MAC). An example of onsite transfer is illustrated in table 1 below:

TABLE 1
An example of onsite transfer analyzed at EVSE level

| Charging | EVSE | MAC | First | Last | | | | Rolling | Onsite |
|---|---|---|---|---|---|---|---|---|---|
| Station ID | ID | ID | Session | Session | Sessions | pₑᵥₛₑ | p_{mac} | MAC? | Transfer? |
| Station 1 | EVSE 1 | MAC 1 | 2023 Feb. 4 | 2023 Mar. 7 | 7 | 0.13 | 0.23 | True | False |
| Station 1 | EVSE 1 | MAC 2 | 2023 Apr. 1 | 2023 Aug. 10 | 45 | 0.87 | 1.00 | True | False |
| Station 1 | EVSE 2 | MAC 1 | 2023 Mar. 9 | 2023 Oct. 15 | 24 | 1.00 | 0.77 | False | True |

Under this definition, an onsite transfer can be detected at an EVSE level using two steps. First, the MAC address should satisfy the conditions

$${p}_{e v s e} > {p}_{e v s e}^{*} and {p}_{mac} \leq {p}_{mac}^{*}$$

on an EVSE, as addressed above at steps 512 and 514. Second, the MAC address should have appeared on another EVSE at the same charging station prior to its first occurrence at the above EVSE.

If at 516 it is determined that the MAC address has previously appeared in other EVSEs of the same charging station, method 500 proceeds to 528, and the EVSE/MAC address pair is returned as a correct mapping. Alternatively, if at 516 it is determined that the MAC address has not previously appeared in other EVSEs of the same charging station (e.g., the answer is NO), method 500 proceeds to 526, and the connector level analysis is performed for the EVSE/MAC address pair.

Returning to 512, if at 512 it is determined that

$${p}_{m a c} > {p}_{mac}^{*}$$

(e.g., the answer is YES), method 500 proceeds to 518. At 518, method 500 includes determining whether

$${p}_{e v s e} > {p}_{e v s e}^{*} .$$

If at 518 it is determined that

$${p}_{e v s e} > {p}_{e vse}^{*} ,$$

(e.g., the answer is YES), method 500 proceeds to 528, and the EVSE/MAC address pair is returned as a correct mapping. Alternatively, if at 518 it is determined that

$${p}_{e v s e} \leq {p}_{e vse}^{*} ,$$

(e.g., the answer is NO), method 500 proceeds to 522.

At 522, method 500 includes determining whether a number of series of rolling MAC addresses plus a number of stationary MAC addresses is less than or equal to the number of connectors of the EVSE. A series of rolling, non-overlapping MAC addresses may be defined as a rolling MAC series, or RM series. At any time, the total count of RM series and stationary MAC addresses (SM) in an EVSE should not exceed its number of connectors, as shown below in equation 8:

$$\sum RM series + \sum S M \leq {n}_{c o n n} \qquad ( 8 )$$

In scenarios where more than one RM series can be identified, it is recommended to analyze mapping at connector level. For example, in Table 2 below, an identification of the correct RM series is ambiguous: while it makes sense to have 2 RM series (MAC1+MAC4 and MAC2+MAC3), it is also theoretically possible to have 1 RM series (MAC2+MAC4) and 2 SM (MAC1 and MAC3).

TABLE 2
An example of more than 1 RM series identified on
1 EVSE creates ambiguity in identifying RM series

| | | | | | | |
|---|---|---|---|---|---|---|
| EVSE | Connectors | MAC | First | Last | | RM |
| ID | per EVSE | ID | Session | Session | Sessions | Series ID |

Table 2-1: Interpretation A

| | | | | | | |
|---|---|---|---|---|---|---|
| EVSE 1 | 2 | MAC 1 | 2023 Feb. 2 | 2023 May 2 | 23 | 1 |
| EVSE 1 | 2 | MAC 2 | 2023 Feb. 7 | 2023 Mar. 30 | 21 | 2 |
| EVSE 1 | 2 | MAC 3 | 2023 Apr. 1 | 2023 Oct. 14 | 102 | 2 |
| EVSE 1 | 2 | MAC 4 | 2023 May 11 | 2023 Aug. 21 | 37 | 1 |

Table 2-2: Interpretation B

| | | | | | | |
|---|---|---|---|---|---|---|
| EVSE 1 | 2 | MAC 1 | 2023 Feb. 2 | 2023 May 2 | 23 | N/A |
| EVSE 1 | 2 | MAC 2 | 2023 Feb. 7 | 2023 Mar. 30 | 21 | 1 |
| EVSE 1 | 2 | MAC 3 | 2023 Apr. 1 | 2023 Oct. 14 | 102 | N/A |
| EVSE 1 | 2 | MAC 4 | 2023 May 11 | 2023 Aug. 21 | 37 | 1 |

Such ambiguity can be resolved by mapping charging sessions to connectors, because each connector is limited to one SM or one RM series. The process of connector level analysis is described below in reference to FIG. 6. The resolution of ambiguity in Table 2 using connector level analysis is shown in Table 3.

TABLE 3
Results of resolving ambiguity from more than 1 RM
series in an EVSE using connector level analysis

| EVSE | Connector | MAC | First | Last | | RM |
|---|---|---|---|---|---|---|
| ID | ID | ID | Session | Session | Sessions | Series ID |
| EVSE 1 | 1 | MAC 1 | 2023 Feb. 2 | 2023 May 2 | 23 | 1 |
| EVSE 1 | 1 | MAC 4 | 2023 May 11 | 2023 Aug. 21 | 37 | 1 |
| EVSE 1 | 2 | MAC 2 | 2023 Feb. 7 | 2023 Mar. 30 | 21 | 2 |
| EVSE 1 | 2 | MAC 3 | 2023 Apr. 1 | 2023 Oct. 14 | 102 | 2 |

It should be appreciated that although the connector level analysis brings more clarity to the mapping, it is not recommended to skip the EVSE level mapping and start with connector level analysis, because connector-level data often has worse data quality than EVSE-level data. Starting with EVSE level mapping, then using connector level analysis for clarification achieves optimum mapping outcomes at the EVSE level.

Thus, if at 522 the number of RM series plus the number of stationary MAC addresses is less than or equal to the number of connectors of the EVSE, method 500 proceeds to 524. At 524, method 500 includes determining whether a sum of the

$${p}_{e v s e} > {p}_{e v s e}^{*} .$$

This step checks whether the identified rolling MAC addresses (and stationary MAC addresses) of an EVSE represents a majority of charge events occurred in this EVSE. If at 524 it is determined that the sum of the

$${P}_{evse} > {P}_{evse}^{*} ,$$

method 500 proceeds to 528, and the EVSE/MAC address pair is returned as a correct mapping. Alternatively, if at 524 it is determined that the sum of

$${P}_{evse} > {P}_{evse}^{*} ,$$

this indicates MAC addresses mapped at EVSE level cannot capture a majority of charge events of the EVSE, and method 500 proceeds to 526, where method 500 includes performing a connector-level analysis of the EVSE/MAC address pair.

Returning to 510, if at 510 it is determined that the MAC address of the EVSE/MAC address pair is a rolling MAC address, method 500 proceeds to 520. At 520, method 500 includes determining whether a number of rolling MAC address series at the EVSE is greater than 1. If the number of rolling MAC address series at the EVSE is greater than 1, method 500 proceeds to 526, where method 500 includes performing a connector-level analysis of the EVSE/MAC address pair. Alternatively, if the number of rolling MAC address series at the EVSE is not greater than 1, method 500 proceeds to 522, where the number of rolling MAC addresses and number of stationary MAC addresses is compared with the number of connectors, as described above.

FIG. 6 shows an exemplary method 600 for performing a connector-level analysis of a pairing of a MAC address with an EVSE ID resulting from the EVSE-level analysis described above in reference to FIG. 5. Because EVSEs with multiple connectors may have multiple MAC addresses associated with the EVSEs, the EVSE-level analysis of FIG. 5 may not be sufficient to resolve all MAC address/EVSE ambiguities. When connector IDs are available in EVSE records for the steps in FIG. 4, method 600 may be performed by the same cloud-based server as method 500. If the connector IDs are not available in charger records, method 600 may be skipped, and outcomes may only be reported based on the EVSE-MAC analysis.

Method 600 starts at 602, where method 600 includes receiving an EVSE/MAC address pair generated from the EVSE-level analysis of method 500. Assuming connector IDs are available for each EVSE/MAC address pair, the received EVSE/MAC address pairs are analyzed in connector/MAC address pairs. However, the connector/MAC address pairs of an EVSE may not be reported.

At 604, method 600 includes removing noise based on connector loyalty and MAC address loyalty, using a similar process as described in reference to method 500 with respect to EVSE loyalty. Thus, at 606, removing the noise includes calculating connector loyalty and MAC address loyalty for the connector-MAC address pair (e.g., each connector of the EVSE-MAC address pair), and identifying whether the connector-MAC address pair is a rolling MAC address.

For the connector-level analysis, EVSE loyalty may be replaced by connector loyalty. Connector loyalty is defined as a number between 0 and 1 corresponding to a ratio of the number of charging sessions of a connector-MAC address combination to the total number of charging sessions of a connector, assuming that the charging sessions are mapped at a connector level (e.g., that MAC addresses are paired with connectors, rather than with EVSEs). This parameter may be greater than a user defined threshold,

$${p}_{conn}^{*} ,$$

such that the mapped MAC address represents a majority of the charging sessions at a connector, assuming the mapped MAC address is not subject to rolling MAC address. Each connector should have no more than 1 MAC address. The connector loyalty may be calculated in accordance with equation 20 below:

$${p}_{conn} = \frac{{CS}_{conn , mac}}{{CS}_{conn}} > {p}_{conn}^{*} \qquad ( 20 )$$

Additionally, when performing the connector level analysis, MAC address loyalty may be alternatively calculated using equation 21 below, as opposed to equation 7:

$${P}_{mac} = \frac{{CS}_{conn , mac}}{{CS}_{station , mac}} > {p}_{mac}^{*} \qquad ( 21 )$$

At 610, method 600 includes determining, for each connector/MAC address pair, whether the MAC address is a rolling MAC address. If at 610 it is determined that the EVSE/MAC address pair is not a rolling MAC address, method 600 proceeds to 612.

At 610, method 600 includes determining, for the connector/MAC address pair, whether

$${p}_{mac} > {p}_{mac}^{*} .$$

If at 610 it is determined that

$${p}_{mac} \leq {p}_{mac}^{*}$$

(e.g., the answer is NO), method 600 proceeds to 612. At 612, method 600 includes determining whether

$${p}_{conn} > {p}_{conn}^{*} .$$

If at 612 it is determined that

$${p}_{conn} \leq {p}_{conn}^{*} ,$$

(e.g., the answer is NO), method 600 proceeds to 624, where method 600 includes concluding that statistically there is not enough confidence to map the MAC address to the connector, and the connector/MAC address pair is dropped from the mapping table. Alternatively, if at 612 it is determined that

$${p}_{conn} > {p}_{conn}^{*} ,$$

(e.g., the answer is Yes), method 600 proceeds to 614. Thus, similar to method 500, if the connector loyalty and the MAC address loyalty are both above their respective threshold values, it may be inferred that the connector/MAC address pair is a valid pair. If both connector loyalty and MAC address loyalty are below their respective thresholds, the connector-MAC address pair may be dropped from the analysis due to lack of confidence.

At 614, method 600 includes determining whether the MAC address has previously appeared in other EVSEs of the same charging station, as described above in reference to method 500. At a connector level, onsite transfer can be detected in a similar manner as at the EVSE level, with new conditions of

$${p}_{conn} > {p}_{conn}^{*} and {p}_{mac} \leq {p}_{mac}^{*}$$

as reflected by steps 610 and 612 (steps 510 and 512 of method 500).

If at 614 it is determined that the MAC address has previously appeared in other EVSEs of the same charging station, method 600 proceeds to 622, and the connector/MAC address pair is returned as a correct mapping, based on the mapping of the connector with the MAC address. Alternatively, if at 614 it is determined that the MAC address has not previously appeared in other EVSEs of the same charging station (e.g., the answer is NO), method 600 proceeds to 624.

Returning to 610, If at 610 it is determined that

$${p}_{mac} > {p}_{mac}^{*}$$

(e.g., the answer is YES), method 600 proceeds to 616. At 616, method 600 includes determining whether

$${p}_{conn} \leq {p}_{conn}^{*} .$$

If at 616 it is determined that

$${p}_{conn} \leq {p}_{conn}^{*} ,$$

(e.g., the answer is YES), method 600 proceeds to 622, and the connector/MAC address pair is returned as a correct mapping. Alternatively, if at 616 it is determined that

$${P}_{evse} \leq {P}_{evse}^{*} ,$$

(e.g., the answer is NO), method 600 proceeds to 620.

At 620, method 600 includes determining whether only one rolling MAC address series exists at the connector. If the number of RM series is equal to one, method 600 proceeds to 622, and the connector/MAC address pair is returned as a correct mapping. Alternatively, if the number of RM series is more than one, method 600 proceeds to 624, where the connector/MAC address pair is not mapped.

Returning to 608, if it is determined that the MAC address of the EVSE/MAC address pair is a rolling MAC address, method 600 proceeds to 618. At 618, method 600 includes determining whether the connector is mapped as a stationary MAC address or an online transfer. If the connector is mapped as a stationary MAC address or an online transfer, method 600 proceeds to 624. Alternatively, if the connector is not mapped as a stationary MAC address or an online transfer, method 600 proceeds to 620.

Thus, for each charger ID/MAC address pairing of a plurality of charger ID/MAC address pairings generated by following method 400, a multi-step statistical analysis is performed. First, a charger loyalty parameter of the charger associated with the charger ID is calculated, where the charger loyalty parameter is a number between 0 and 1 corresponding to the ratio of a number of charging sessions of the charger ID/MAC address combination to the total number of charging sessions of the charger. A MAC address loyalty parameter of the charger associated with the charger ID is also calculated, where the MAC address loyalty parameter is a number between 0 and 1 corresponding to the ratio of the number of charging sessions of the charger ID/MAC address combination to a total number of charging sessions including the MAC address. If the MAC address is not a rolling MAC address and both of the charger loyalty parameter and the MAC address loyalty parameter are above respective threshold values, a mapped charger ID/MAC address pairing is returned.

Alternatively, if both of the charger loyalty parameter and the MAC address loyalty parameter are below respective threshold values, or if one of the charger loyalty parameter and the MAC address loyalty parameter is below a respective threshold value, and a number of RM series plus a number of non-rolling MAC addresses is greater than a number of connectors of the charger; or if the MAC address is a rolling MAC address and the number of RM series per charger is greater than one, a connector-level analysis is performed on the charger ID/MAC address pairing to determine a correspondence between multiple MAC addresses of the charger and multiple connectors of the charger. When the connector-level analysis of the charger ID/MAC address pairing is performed, for each connector of the charger of the charger ID/MAC address pairing (e.g., a connector/MAC address pairing), a connector loyalty parameter of the connector is calculated, where the connector loyalty parameter is a number between 0 and 1 corresponding to the ratio of a number of charging sessions including a combination of the connector with the MAC address to the total number of charging sessions of the connector. A MAC address loyalty parameter of the connector is also performed, the MAC address loyalty parameter a number between 0 and 1 corresponding to the ratio of the number of charging sessions including a combination of the connector with the MAC address to a total number of charging sessions including the MAC address. If the MAC address is not a rolling MAC address and both of the connector loyalty parameter and the MAC address loyalty parameter are above respective threshold values, a mapped connector/MAC address pairing is returned.

By following methods 3-6, connected vehicle data from a large number of EVs may be leveraged to generate a large and reliable set of EVSE/MAC address pairings, which can be stored in a mapping table in a cloud. The mapping table may then be accessed by a remote, cloud-based authentication system during charging events, to facilitate charging vehicles via the P&A activation framework described above. By collecting the EVSE/MAC pairings in the manner described above, the mapping table may be more comprehensive and robust than by collecting EVSE/MAC pairings in a piecemeal fashion and/or via other alternative methods.

However, the P&A framework may not be supported by all CPOs, and some CPOs may have a preference for activating vehicles via the P&C framework. P&A caters to different use cases from P&C. Unlike P&C, P&A does not rely on the charging EVSE to support its communication protocol on ISO handshake. Thus, P&A can be utilized as long as the EVSE has a consistent MAC address and supports remote activation. Additionally, P&A can support personal profiles via cloud communication. For instance, ISO contract certificates are tied to a vehicle, and there is one account tied to paying for P&C events on that vehicle. With personal profiles, a cloud-based server (e.g., cloud-based server 107 of FIG. 1) could track who is logged in to drive the vehicle. When a plug-in alert is sent to the cloud-based server, the system can bill an individual user, rather than the one owner of the vehicle. Similarly, a person may enroll in a number of charging management systems or e-Mobility Service Providers (eMSPs) for discounted pricing. With P&A, the cloud-based server can determine individual memberships applicable to the plug-in attempt, and send the remote activation request to the preferred provider. For instance, a person could be enrolled in five different eMSPs in the European Union, and plug into an EVSE, but each eMSP may have a different rate for the energy delivered. In contrast, P&C enables the cloud-based server to choose a low resource eMSP and send the activation request to that provider, saving the customer money. With P&C, there is one active CMS or eMSP on the vehicle, and there is no ability for customers to easily select preferred eMSPs for each charging event.

As a result, some EVs approaching a charging station to receive a charge may be charged via the P&C framework, while other EVs may be charged via the P&A framework. In still other cases, for example, if authentication is not successful within either of the P&C and P&A frameworks, an EV may be charged via a different remote activation method, or manually by a driver of the EV using an EVSE interface. For this reason, methods are provided in FIGS. 7-9 for selecting between P&C charging and P&A charging for different EVs and charging sessions based on efficiency and CPO preferences, and defaulting to other remote activation and/or manual methods if authentication cannot be performed under either of the P&C and P&A frameworks. Since P&A and P&C cater to different use cases, implementing a charging method that can intelligently detect and employ both P&A and P&C will expand the range of use cases.

Referring now to FIG. 7, an exemplary method 700 is shown for managing an authentication procedure between an EV and an EVSE of a charging station, such as EV 202 and EVSE 228 of charging station 220 of FIG. 2, where the authentication procedure may be based on a P&A framework that relies on the EVSE/MAC address pairings generated in accordance with methods 400, 500, and 600 described above, or a P&C framework in the event that the P&A framework is not supported. Thus, method 700 combines the P&A feature with the industry-standard P&C feature to maximize the benefits of automatic charging. Moreover, by seamlessly switching to an alternative approach should one degrade, method 700 may also reduce a likelihood of charging issues. Method 700 may be executed by a controller of the EV, such as controller 210 of FIG. 2.

Method 700 begins at 702, where method 700 includes measuring/estimating vehicle operating conditions. Measuring/estimating the vehicle operating conditions may include determining an SOC of the battery, estimating a current consumption of stored energy of the EV, and/or other operating conditions, as well as determining whether the vehicle is being propelled by the battery or whether the vehicle is stopped. For example, the vehicle may be parked at the charging station.

At 704, method 400 includes determining whether a connection request is received from the charging station. In various examples, a connection with the EV may be requested when the EV is positioned at a designated charging location of the charging station, where the designated charging location may be a location proximate to the EVSE. In other words, in preparation for charging the EV, the EV may be navigated to the charging location, and when the EV is detected by the charging station at the charging location, the charging station may send the connection request. In various embodiments, the connection request may be sent by a communication module of the charging station (e.g., communication module 226 of FIG. 2).

If at 704 the connection request is not received from the charging station, method 700 proceeds to 706. At 706, method 700 includes maintaining the operating conditions of the vehicle until the connection request is received. Alternatively, if the connection request is received at 704, method 700 proceeds to 708. At 708, method 700 includes establishing a connection with the charging station, where the connection is a wireless communication connection.

At 710, method 700 includes receiving a MAC address from the EVSE. The MAC address may be sent from the EVSE to the EV upon an initialization of the connection.

At 712, method 700 includes initiating P&C communications and P&A communications in parallel. In other words, a first authentication under the P&C framework may be performed concurrently and independently with a second authentication under the P&A framework. At 714, initiating the P&C communications and the P&A communications in parallel includes sending a plug-in alert with a GPS location of the EV and the received MAC address to a remote authentication system for authenticating the connection with the EVSE under the P&A framework. In various embodiments, the remote authentication system may be hosted by a cloud-based server, such as server 107 of FIG. 1. The remote authentication under P&A is described below in reference to FIG. 8.

At 716, initiating the P&C communications and the P&A communications in parallel includes exchanging digital certificates with the EVSE for the P&C authentication. During the P&C authentication, a TLS handshake may be performed using the digital certificates as described above, where the EV and the EVSE execute a series of steps to authenticate each other, agree on encryption standards, and establish a connection. If the TLS handshake is successful, meaning, if valid certificates are exchanged between the EV and the EVSE, the EV may be authenticated via P&C. If the authentication via P&C is not successful, the EV may not be authenticated via P&C.

At 718, method 700 includes determining whether P&C is a preferred activation method for the CPO. In various embodiments, step 718 may be performed while authentication under P&C and/or P&A is being performed. The preferred activation method of the CPO for the EV may be stored in a user-preference table stored in the cloud, such as the exemplary user-preference table shown in Table 4 below:

TABLE 4
An example of user-preference table on
charging activation approach per CPO

| | User-Preferred |
|---|---|
| CPO | Charging Activation Approach |
| Tesla | Plug & Charge |
| Electrify America | Plug & Activate |
| EVgo | Plug & Activate |
| ChargePoint | Plug & Charge |

If P&C is the preferred activation method for the CPO, method 700 proceeds to 720. At 720, method 700 includes determining whether the authentication in accordance with P&C is successful. If the P&C authentication is successful, charging may be activated via P&C by the CPO, whereby method 700 proceeds to 724, and method 700 includes receiving a charge via P&C. Method 700 ends.

Alternatively, if at 718 it is determined that P&C is not the preferred activation method for the CPO, or if the P&C authentication at 720 is unsuccessful, method 700 proceeds to 726. At 726, method 700 includes determining whether the authentication in accordance with P&A is successful. If the P&A authentication is successful, a remote activation request for the EVSE ID associated with the MAC address may be sent to the CPO via the CMS. In response to receiving the remote activation request, the CPO may activate charging via the P&A framework, whereby method 700 proceeds to 728. At 728, method 700 includes receiving a charge via P&A, and method 700 ends.

Alternatively, if at 726 the P&A authentication is unsuccessful, method 700 proceeds to 732. At 732, method 700 includes determining whether the P&C authentication was successful (e.g., in the case where method 700 proceeds to 726 via 718). If the P&A authentication is unsuccessful at 726, and the P&C authentication is successful at 732, then the CPO may activate charging via the P&C framework, whereby method 700 proceeds to 734. At 734, method 700 includes receiving a charge via P&C, and method 700 ends.

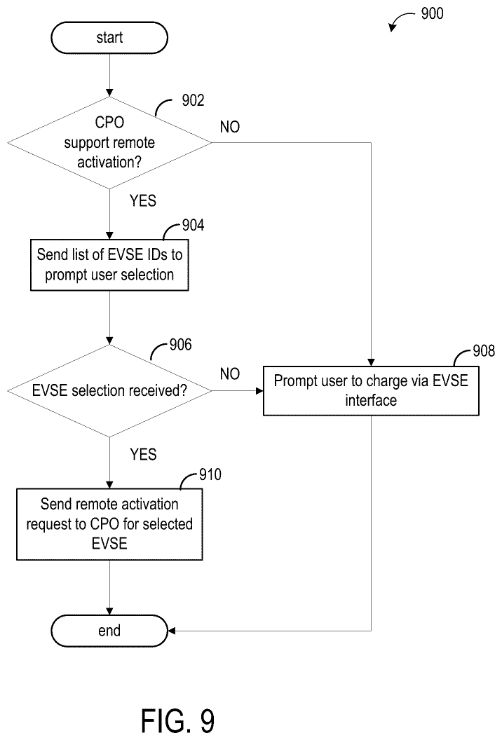

However, if the P&A authentication is unsuccessful at 726 and the P&C authentication is unsuccessful at 732, method 700 proceeds to 736. At 736, method 700 includes attempting to receive a charge without using either of the P&C framework or the P&A framework. Receiving the charge without using either of the P&C framework or the P&A framework is described below in reference to FIG. 9.

FIG. 8 shows an exemplary method 800 for authenticating an EV at a charging station for receiving a charge using the P&A framework described above, where method 800 is performed by a remote authentication system (e.g., remote authentication system 106) installed on a server in a cloud based on a table of EVSE/MAC address pairings generated in accordance with methods 400, 500, and 600 of FIGS. 4, 5, and 6, respectively. The server may be the same as or similar to cloud-based server 107 of FIG. 1, and the table of EVSE/MAC address pairings may be stored in a database such as database 109 of cloud 108.

Method 800 begins at 802, where method 800 includes receiving a GPS location of the EV and a MAC address of an EVSE connected to the EV. At 804, method 800 includes identifying a location of a charging station and a CPO of the EVSE, based on the received GPS location. In various embodiments, the location of the charging station may be retrieved from a database of charging stations stored in the cloud, where the database includes location data of a plurality of charging stations associated with one or more CPOs.

At 806, method 800 includes identifying an EVSE ID of the EVSE based on the received MAC address, using the table of EVSE/MAC address pairings generated in accordance with the methods of FIGS. 3-6 described above. At 808, method 800 includes determining whether the EVSE ID is identified from the EVSE-MAC address mapping. If the EVSE ID is identified from the EVSE-MAC address mapping, then method 800 proceeds to 810. If the EVSE ID is not identified from the EVSE-MAC address mapping, then method 800 proceeds to 812, where method 800 returns a invalid P&A authentication, and method 800 ends.

At 810, method 800 includes determining an enrollment status of the EV based on a vehicle identification number (VIN) of the EV or a user of the vehicle. Depending on a contract between the vehicle manufacturer/owner and the CPOs, the EV could have different enrollment status with respect to CPOs, which may affect charging success, activation method and billing. In accordance with the enrollment status, at 814, method 800 includes determining whether CPO qualifies for activation via the P&A framework. If the CPO does not qualify for activation via the P&A framework, method 800 proceeds to 812, where method 800 returns an invalid authentication, and method 800 ends. Alternatively, if the CPO qualifies for activation via the P&A framework, method 800 proceeds to 816. At 816, method 800 returns a successful P&A authentication, and method 800 ends.

FIG. 9 shows an exemplary method 900 for activating charging of an EV at a charging station in a case where the EV is not authenticated either using a P&A framework or a P&C framework, as described in reference to FIGS. 7 and 8. Method 900 may be performed by a remote authentication server in a cloud, such as cloud-based server 107 of FIG. 1.

Method 900 begins at 902, where method 900 includes determining whether the CPO supports remote activation. If at 902 it is determined that the CPO supports remote activation, method 900 proceeds to 904.

At 904, method 900 includes sending a list of candidate EVSEs (e.g., ESVE IDs) to the EV for the user to select the appropriate EVSE for charging. The list of candidate EVSEs may be a list of EVs associated with the charging station, which may be stored in a database of the remote authentication server.

At 906, method 900 includes determining whether a selection of an EVSE of the list of candidate EVSEs has been made by the user. If a user selection of the EVSE is received at 906, method 900 proceeds to 910, where method 900 includes sending a remote activation request for the EVSE ID of the selected EVSE to the CPO via the CMS, to initiate charging using remote activation, and method 900 ends.

Alternatively, if at 902 it is determined that the CPO does not support remote activation, or if at 906 no user selection of an EVSE is received, method 900 proceeds to 908. At 908, method 900 includes prompting the user to initiate charging with the EVSE using an interface of the EVSE (meaning, not using either of P&C or P&A). When the user initiates charging with the EVSE using the interface of the EVSE, the user may manually enter in a charging method to receive a charge via the EVSE. Method 900 ends.

Thus, in essence, methods 700, 800, and 900 initially attempt to establish communication via both P&A and P&C simultaneously. A CPO preference is read on charging activation approaches from a table stored in a cloud. In accordance with method 700, the EV then attempts to initiate charging prioritizing the preferred activation framework. If the CPO-preferred activation method does not complete or is invalid, the method automatically attempts the other activation approach. If neither activation approach is able to authenticate, the method will then prompt the user to manually select the EVSE for remote activation, in accordance with method 900. In the worst-case scenario—if the CPO does not support remote activation or if the user declines the selection—the user can make payment and initiate charging using the conventional, manual method available on the EVSE interface.

In this way, robust methods are proposed both for generating a reliable set of EVSE/MAC address pairings that can be used to determine EVSE IDs for authenticating EVs during charging sessions based on MAC addresses received by the EVs from a charging EVSE, and also to manage the authentication of the charging sessions based on CPO preferences, where both P&A and P&C charging is supported and one charging framework (either P&A or P&C) may be substituted for another in the event of an invalid or incomplete authentication. The technical effect of providing methods for charging an EV using either of, or a combination of P&A and P&C, is that a number of invalid or incomplete authentications may be reduced while maintaining user interaction with a charging system at a minimum. The technical effect of generating the set of EVSE/MAC address pairings based on matching historical charging data of a plurality of connected vehicles with historical charging data of a set of EVSEs of a CPO and aggregating the pairings using the described statistical methods is that a comprehensiveness and accuracy of the set of EVSE/MAC address pairings may be increased, resulting in a more efficient charging process. In particular, the use of PKI certificates relied on by P&C may be reduced, decreasing a complexity and a number of computational operations performed during the charging process.

The disclosure also provides support for a method, comprising: generating, from charging data collected from a plurality of charging sessions recorded between a plurality of electric vehicles (EVs) and a plurality of chargers, a set of pairings of IDs of the chargers with medium access control (MaC) addresses of the chargers, the set of ID/MAC address pairings used to authenticate an EV of the plurality of EVs and a charger of the plurality of chargers during a charging session of the EV at the charger, and storing the ID/MAC address pairings in a database in a cloud. In a first example of the method, the method further comprises: receiving a MAC address of a charger of the plurality of chargers from an EV of the plurality of EVs during a charging session of the EV at the charger, identifying an ID of the charger based on the MAC address using the set of ID/MAC address pairings, and sending a remote activation request including the ID to a charge point operator (CPO) of the charger. In a second example of the method, optionally including the first example, generating the set of charger ID/MAC address pairings from charging data collected from the plurality of charging sessions further comprises: requesting and receiving a first set of connected vehicle charging data of the plurality of EVs, via a wireless network connection, requesting and receiving a second set of CPO charging data of the plurality of chargers from a CPO of the chargers, filtering the first set of connected vehicle charging data based on charging session duration, and filtering the connected vehicle charging data to remove non-valid MAC addresses. In a third example of the method, optionally including one or both of the first and second examples, the method further comprises: for each charging session of the filtered connected vehicle charging data: extracting a GPS location and timestamp data of the charging session, matching an EV of the charging session to a charging station in the second set of CPO charging data, based on the extracted GPS location and timestamp data, and matching the MAC address received by the EV from a charger of the charging station to a charger ID of the charger based on the extracted timestamp data. In a fourth example of the method, optionally including one or more or each of the first through third examples, the method further comprises: filtering the first set of connected vehicle charging data to remove chargers that have less than a threshold number of charging sessions. In a fifth example of the method, optionally including one or more or each of the first through fourth examples, the method further comprises: for each charger ID/MAC address pairing of the charger ID/MAC address pairings: calculating a charger loyalty parameter of the charger associated with the charger ID, the charger loyalty parameter a number between 0 and 1 corresponding to a ratio of a number of charging sessions of the charger ID/MAC address pairing to a total number of charging sessions of the charger, calculating a MAC address loyalty parameter of the charger associated with the charger ID, the MAC address loyalty parameter a number between 0 and 1 corresponding to a ratio of the number of charging sessions of the charger ID/MAC address pairing to a total number of charging sessions including the MAC address, identifying whether the MAC address is a rolling MAC address, the rolling MAC address a new MAC address in a sequence of consecutive charging sessions, and in response to the MAC address not being a rolling MAC address and both of the charger loyalty parameter and the MAC address loyalty parameter being above respective threshold values, storing a mapped charger ID/MAC address pairing. In a sixth example of the method, optionally including one or more or each of the first through fifth examples, the method further comprises: detecting one of: both of the charger loyalty parameter and the MAC address loyalty parameter being below respective threshold values, one of the charger loyalty parameter and the MAC address loyalty parameter being below a respective threshold value, and a number of series of rolling MAC addresses plus a number of non-rolling MAC addresses being greater than a number of connectors of the charger, and the MAC address being a rolling MAC address and the number of rolling MAC addresses per charger being greater than one, and in response, performing a connector-level analysis of the charger ID/MAC address pairing to determine a correspondence between multiple MAC addresses of the charger and multiple connectors of the charger. In a seventh example of the method, optionally including one or more or each of the first through sixth examples, performing the connector-level analysis of the charger ID/MAC address pairing further comprises: for each connector of the charger of the charger ID/MAC address pairing: calculating a connector loyalty parameter of the connector, the connector loyalty parameter a number between 0 and 1 corresponding to a ratio of a number of charging sessions including a combination of the connector with the MAC address to the total number of charging sessions of the connector, calculating a MAC address loyalty parameter of the connector, the MAC address loyalty parameter a number between 0 and 1 corresponding to a ratio of the number of charging sessions including a combination of the connector with the MAC address to a total number of charging sessions including the MAC address, and in response to the MAC address not being a rolling MAC address and both of the connector loyalty parameter and the MAC address loyalty parameter being above respective threshold values, storing a mapped connector/MAC address pairing.

The disclosure also provides support for a method for a controller of an electric vehicle (EV), the method comprising: establishing a communication connection between the EV and a charger of a plurality of chargers of a charging station of a charge point operator (CPO), determining a preferred activation method of the CPO, the preferred activation method one of a first Plug & Charge (P&C) activation method relying on encrypted public key infrastructure (PKI) certificates, and a second Plug & activate (P&a) activation method not relying on encrypted PKI certificates, authenticating the EV for the preferred activation method via a remote authentication system in a cloud, receiving a charge from the charger, the charge activated by the CPO in response to the remote authentication system authenticating the EV. In a first example of the method, authenticating the EV for the preferred activation method via the remote authentication system further comprises: initiating P&A communications with the remote authentication system to authenticate the EV and the charger via the P&A activation method, and initiating P&C communications with the remote authentication system to authenticate the EV and the charger via the P&C activation method in parallel. In a second example of the method, optionally including the first example, the method further comprises: in response to the P&C activation method not being authenticated and the P&A activation method being authenticated, receiving a charge via P&A as a result of the remote authentication system sending a request to the CPO to remotely activate the charger via the P&A activation method, in response to the P&A activation method not being authenticated and the P&C activation method being authenticated, receiving a charge via P&C as a result of the remote authentication system sending a request to the CPO to remotely activate the charger via the P&C activation method, and in response to both of the P&A activation method and the P&C activation method not being authenticated and the CPO supporting remote activation of the charger, sending a list of charger IDs to a user of the EV and prompting the user to select a charger ID of the charger. In a third example of the method, optionally including one or both of the first and second examples, the method further comprises: in response to receiving a selection of the charger ID from the user, sending a request to the CPO to remotely activate the charger, the request including the ID, and in response to not receiving the selection of the charger ID from the user or the CPO not supporting the remote activation of the charger, prompting the user to charge the EV via an interface of the charger. In a fourth example of the method, optionally including one or more or each of the first through third examples, the preferred activation method is the P&A activation method, and initiating the P&A communications with the remote authentication system to authenticate the EV and the charger via the P&A activation method further comprises: receiving a medium access control (MAC) address of the charger from the charger via the communication connection, and sending the MAC address and global positioning system (GPS) location data of the EV to the remote authentication system. In a fifth example of the method, optionally including one or more or each of the first through fourth examples, the EV is authenticated by the remote authentication system by determining an ID of the charger based on the MAC address and the GPS location data, using a set of charger ID/MAC address pairings stored in a cloud, the set of charger ID/MAC address pairings generated from data collected from a plurality of prior charging sessions recorded between a plurality of EVs and the plurality of chargers.

The disclosure also provides support for a remote authentication system for authenticating a charging session of an electric vehicle (EV), comprising: a processor, and instructions stored in a memory of the remote authentication system that when executed, cause the processor to: at a first time, generate, from charging data collected from a plurality of charging sessions recorded between a plurality of electric vehicles (EVs) and a plurality of chargers, a set of pairings of IDs of the chargers with medium access control (MaC) addresses of the chargers, and store the charger ID/MAC address pairings in a database, and at a second time: receive a MAC address of a charger of the plurality of chargers from an EV of the plurality of EVs during a charging session of the EV at the charger, identify an ID of the charger based on the Mac address using the set of ID/MaC address pairings, authenticate the charging session based on the ID, and in response to the charging session being authenticated, send a remote activation request to a charge point operator (CPO) of the EV to initiate charging of the EV at the charger. In a first example of the system, further instructions are stored in the memory, that when executed, cause the processor to: request and receive a first set of charging data of the plurality of EVs via a wireless network connection, request and receive a second set of CPO charging data of the plurality of chargers from a CPO of the chargers, for each charging session of the first set of charging data: extract a GPS location and timestamp data of the charging session, match an EV of the charging session to a charging station in the second set of CPO charging data, based on the extracted GPS location and timestamp data, and match the MAC address received by the EV from a charger of the charging station to a charger ID of the charger based on the extracted timestamp data. In a second example of the system, optionally including the first example, further instructions are stored in the memory, that when executed, cause the processor to: eliminate charging sessions having non-valid MAC addresses or a duration that is less than a threshold duration from the first set of charging data, and eliminate chargers that have less than a threshold number of charging sessions from the first set of charging data. In a third example of the system, optionally including one or both of the first and second examples, further instructions are stored in the memory, that when executed, cause the processor to: for each charger ID/MAC address pairing of the charger ID/MAC address pairings: calculate a charger loyalty parameter of the charger associated with the charger ID, the charger loyalty parameter a number between 0 and 1 corresponding to a ratio of a number of charging sessions of the charger ID/MAC address pairing to a total number of charging sessions of the charger, calculate a MAC address loyalty parameter of the charger associated with the charger ID, the MAC address loyalty parameter a number between 0 and 1 corresponding to a ratio of the number of charging sessions of the charger ID/MAC address pairing to a total number of charging sessions including the MAC address, identify whether the MAC address is a rolling MAC address, the rolling MAC address a new MAC address in a sequence of consecutive charging sessions, and in response to the MAC address not being a rolling MAC address and both of the charger loyalty parameter and the MAC address loyalty parameter being above respective threshold values, store a mapped charger ID/MAC address pairing in the memory. In a fourth example of the system, optionally including one or more or each of the first through third examples, further instructions are stored in the memory, that when executed, cause the processor to: in response to one of: both of the charger loyalty parameter and the MAC address loyalty parameter being below respective threshold values, one of the charger loyalty parameter and the MAC address loyalty parameter being below a respective threshold value, and a number of series of rolling MAC addresses plus a number of non-rolling MAC addresses being greater than a number of connectors of the charger, and the MAC address being a rolling MAC address and the number of series of rolling MAC addresses per charger being greater than one, perform a connector-level analysis of the charger ID/MAC address pairing to determine a correspondence between multiple MAC addresses of the charger and multiple connectors of the charger. In a fifth example of the system, optionally including one or more or each of the first through fourth examples, further instructions are stored in the memory, that when executed, cause the processor to: during the connector-level analysis of the charger ID/MAC address pairing: for each connector of the charger of the charger ID/MAC address pairing: calculate a connector loyalty parameter of the connector, the connector loyalty parameter a number between 0 and 1 corresponding to a ratio of a number of charging sessions including a combination of the connector with the MAC address to a total number of charging sessions of the connector, calculate a MAC address loyalty parameter of the connector, the MAC address loyalty parameter a number between 0 and 1 corresponding to a ratio of the number of charging sessions including a combination of the connector with the MAC address to a total number of charging sessions including the MAC address, and in response to the MAC address not being a rolling MAC address and both of the connector loyalty parameter and the MAC address loyalty parameter being above respective threshold values, store a mapped connector/MAC address pairing in the memory.

The methods and systems described herein provide a technical solution to the issue of reliably authenticating electric vehicles (EVs) for charging at electric vehicle supply equipment (EVSEs) using a combination of Plug & Charge (P&C) and Plug & Activate (P&A) authentication frameworks. Example features include detailed technical methods for generating a comprehensive and accurate mapping of EVSE IDs to MAC addresses by leveraging historical charging data from a large number of connected EVs and EVSEs, including more than could be managed manually or mentally by humans. This involves filtering the data, performing statistical analysis at both the EVSE and connector level, and identifying valid EVSE-MAC address pairings. This technical process results in a more reliable and robust mapping table compared to piecemeal data collection methods.

Further, the specific techniques herein include operation of EV authentication with an EVSE using both the P&C and P&A frameworks in parallel, and seamlessly switching between the two frameworks based on the success of the authentication. This represents a technical advancement over previous approaches, such as those that relied solely on the more complex P&C framework, or that used multiple frameworks. The technical components described include the remote authentication system that stores the EVSE-MAC address mapping and performs the authentication, as well as the interactions between the EV, EVSE, and remote authentication system during the charging process.

Technical effects achieved also include reducing invalid authentications, decreasing complexity and computational operations compared to the prior art P&C framework, and supporting advanced use cases like vehicle sharing and EV ownership assignment. In this way, the disclosed approaches demonstrate specific technological solutions to technical issues in the field of electric vehicle charging authentication.

The specific routines described herein may represent one or more of any number of processing strategies such as event-driven, interrupt-driven, multi-tasking, multi-threading, and the like. As such, various actions, operations, and/or functions illustrated may be performed in the sequence illustrated, in parallel, or in some cases omitted. Likewise, the order of processing is not necessarily required to achieve the features and advantages of the examples described herein, but is provided for ease of illustration and description. One or more of the illustrated actions, operations, and/or functions may be repeatedly performed depending on the particular strategy being used. Further, the described actions, operations, and/or functions may graphically represent code to be programmed into non-transitory memory of the computer readable storage medium in the engine control system, where the described actions are carried out by executing the instructions in a system including the various engine hardware components in combination with the electronic controller.

It will be appreciated that the configurations and routines disclosed herein are exemplary in nature, and that these specific embodiments are not to be considered in a limiting sense, because numerous variations are possible. Moreover, unless explicitly stated to the contrary, the terms “first,” “second,” “third,” and the like are not intended to denote any order, position, quantity, or importance, but rather are used merely as labels to distinguish one element from another. The subject matter of the present disclosure includes all novel and non-obvious combinations and sub-combinations of the various systems and configurations, and other features, functions, and/or properties disclosed herein.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A method, comprising:
generating, from charging data collected from a plurality of charging sessions recorded between a plurality of electric vehicles (EVs) and a plurality of chargers, a set of pairings of IDs of the chargers with medium access control (MAC) addresses of the chargers, the set of ID/MAC address pairings used to authenticate an EV of the plurality of EVs and a charger of the plurality of chargers during a charging session of the EV at the charger; and
storing the ID/MAC address pairings in a database in a cloud.

2. The method of claim 1, further comprising:
receiving a MAC address of a charger of the plurality of chargers from an EV of the plurality of EVs during a charging session of the EV at the charger;
identifying an ID of the charger based on the MAC address using the set of ID/MAC address pairings; and
sending a remote activation request including the ID to a charge point operator (CPO) of the charger.

3. The method of claim 1, wherein generating the set of charger ID/MAC address pairings from charging data collected from the plurality of charging sessions further comprises:
requesting and receiving a first set of connected vehicle charging data of the plurality of EVs, via a wireless network connection;
requesting and receiving a second set of CPO charging data of the plurality of chargers from a CPO of the chargers;
filtering the first set of connected vehicle charging data based on charging session duration; and
filtering the connected vehicle charging data to remove non-valid MAC addresses.

4. The method of claim 3, further comprising:
for each charging session of the filtered connected vehicle charging data:
extracting a GPS location and timestamp data of the charging session;
matching an EV of the charging session to a charging station in the second set of CPO charging data, based on the extracted GPS location and timestamp data; and
matching the MAC address received by the EV from a charger of the charging station to a charger ID of the charger based on the extracted timestamp data.

5. The method of claim 4, further comprising:
filtering the first set of connected vehicle charging data to remove chargers that have less than a threshold number of charging sessions.

6. The method of claim 4, further comprising:
for each charger ID/MAC address pairing of the charger ID/MAC address pairings:
calculating a charger loyalty parameter of the charger associated with the charger ID, the charger loyalty parameter a number between 0 and 1 corresponding to a ratio of a number of charging sessions of the charger ID/MAC address pairing to a total number of charging sessions of the charger;
calculating a MAC address loyalty parameter of the charger associated with the charger ID, the MAC address loyalty parameter a number between 0 and 1 corresponding to a ratio of the number of charging sessions of the charger ID/MAC address pairing to a total number of charging sessions including the MAC address;
identifying whether the MAC address is a rolling MAC address, the rolling MAC address a new MAC address in a sequence of consecutive charging sessions; and
in response to the MAC address not being a rolling MAC address and both of the charger loyalty parameter and the MAC address loyalty parameter being above respective threshold values, storing a mapped charger ID/MAC address pairing.

7. The method of claim 6, further comprising:
detecting one of:
both of the charger loyalty parameter and the MAC address loyalty parameter being below respective threshold values;
one of the charger loyalty parameter and the MAC address loyalty parameter being below a respective threshold value, and a number of series of rolling MAC addresses plus a number of non-rolling MAC addresses being greater than a number of connectors of the charger; and
the MAC address being a rolling MAC address and the number of rolling MAC addresses per charger being greater than one;
and in response, performing a connector-level analysis of the charger ID/MAC address pairing to determine a correspondence between multiple MAC addresses of the charger and multiple connectors of the charger.

8. The method of claim 7, wherein performing the connector-level analysis of the charger ID/MAC address pairing further comprises:
for each connector of the charger of the charger ID/MAC address pairing:
calculating a connector loyalty parameter of the connector, the connector loyalty parameter a number between 0 and 1 corresponding to a ratio of a number of charging sessions including a combination of the connector with the MAC address to the total number of charging sessions of the connector;
calculating a MAC address loyalty parameter of the connector, the MAC address loyalty parameter a number between 0 and 1 corresponding to a ratio of the number of charging sessions including a combination of the connector with the MAC address to a total number of charging sessions including the MAC address; and
in response to the MAC address not being a rolling MAC address and both of the connector loyalty parameter and the MAC address loyalty parameter being above respective threshold values, storing a mapped connector/MAC address pairing.

9. A method for a controller of an electric vehicle (EV), the method comprising:
establishing a communication connection between the EV and a charger of a plurality of chargers of a charging station of a charge point operator (CPO);
determining a preferred activation method of the CPO, the preferred activation method one of a first Plug & Charge (P&C) activation method relying on encrypted public key infrastructure (PKI) certificates, and a second Plug & Activate (P&A) activation method not relying on encrypted PKI certificates;
authenticating the EV for the preferred activation method via a remote authentication system in a cloud;
receiving a charge from the charger, the charge activated by the CPO in response to the remote authentication system authenticating the EV.

10. The method of claim 9, wherein authenticating the EV for the preferred activation method via the remote authentication system further comprises:
initiating P&A communications with the remote authentication system to authenticate the EV and the charger via the P&A activation method, and initiating P&C communications with the remote authentication system to authenticate the EV and the charger via the P&C activation method in parallel.

11. The method of claim 10, further comprising:
in response to the P&C activation method not being authenticated and the P&A activation method being authenticated, receiving a charge via P&A as a result of the remote authentication system sending a request to the CPO to remotely activate the charger via the P&A activation method;
in response to the P&A activation method not being authenticated and the P&C activation method being authenticated, receiving a charge via P&C as a result of the remote authentication system sending a request to the CPO to remotely activate the charger via the P&C activation method; and
in response to both of the P&A activation method and the P&C activation method not being authenticated and the CPO supporting remote activation of the charger, sending a list of charger IDs to a user of the EV and prompting the user to select a charger ID of the charger.

12. The method of claim 11, further comprising:
in response to receiving a selection of the charger ID from the user, sending a request to the CPO to remotely activate the charger, the request including the ID; and
in response to not receiving the selection of the charger ID from the user or the CPO not supporting the remote activation of the charger, prompting the user to charge the EV via an interface of the charger.

13. The method of claim 11, wherein the preferred activation method is the P&A activation method, and initiating the P&A communications with the remote authentication system to authenticate the EV and the charger via the P&A activation method further comprises:
receiving a medium access control (MAC) address of the charger from the charger via the communication connection; and
sending the MAC address and global positioning system (GPS) location data of the EV to the remote authentication system.

14. The method of claim 13, wherein the EV is authenticated by the remote authentication system by determining an ID of the charger based on the MAC address and the GPS location data, using a set of charger ID/MAC address pairings stored in a cloud, the set of charger ID/MAC address pairings generated from data collected from a plurality of prior charging sessions recorded between a plurality of EVs and the plurality of chargers.

15. A remote authentication system for authenticating a charging session of an electric vehicle (EV), comprising:
a processor, and instructions stored in a memory of the remote authentication system that when executed, cause the processor to:
at a first time, generate, from charging data collected from a plurality of charging sessions recorded between a plurality of electric vehicles (EVs) and a plurality of chargers, a set of pairings of IDs of the chargers with medium access control (MAC) addresses of the chargers, and store the charger ID/MAC address pairings in a database; and
at a second time:
receive a MAC address of a charger of the plurality of chargers from an EV of the plurality of EVs during a charging session of the EV at the charger;
identify an ID of the charger based on the MAC address using the set of ID/MAC address pairings;
authenticate the charging session based on the ID; and
in response to the charging session being authenticated, send a remote activation request to a charge point operator (CPO) of the EV to initiate charging of the EV at the charger.

16. The remote authentication system of claim 15, wherein further instructions are stored in the memory, that when executed, cause the processor to:
request and receive a first set of charging data of the plurality of EVs via a wireless network connection;
request and receive a second set of CPO charging data of the plurality of chargers from a CPO of the chargers;
for each charging session of the first set of charging data:
extract a GPS location and timestamp data of the charging session;
match an EV of the charging session to a charging station in the second set of CPO charging data, based on the extracted GPS location and timestamp data; and
match the MAC address received by the EV from a charger of the charging station to a charger ID of the charger based on the extracted timestamp data.

17. The remote authentication system of claim 16, wherein further instructions are stored in the memory, that when executed, cause the processor to:
eliminate charging sessions having non-valid MAC addresses or a duration that is less than a threshold duration from the first set of charging data; and
eliminate chargers that have less than a threshold number of charging sessions from the first set of charging data.

18. The remote authentication system of claim 16, wherein further instructions are stored in the memory, that when executed, cause the processor to:
for each charger ID/MAC address pairing of the charger ID/MAC address pairings:
calculate a charger loyalty parameter of the charger associated with the charger ID, the charger loyalty parameter a number between 0 and 1 corresponding to a ratio of a number of charging sessions of the charger ID/MAC address pairing to a total number of charging sessions of the charger;
calculate a MAC address loyalty parameter of the charger associated with the charger ID, the MAC address loyalty parameter a number between 0 and 1 corresponding to a ratio of the number of charging sessions of the charger ID/MAC address pairing to a total number of charging sessions including the MAC address;
identify whether the MAC address is a rolling MAC address, the rolling MAC address a new MAC address in a sequence of consecutive charging sessions; and
in response to the MAC address not being a rolling MAC address and both of the charger loyalty parameter and the MAC address loyalty parameter being above respective threshold values, store a mapped charger ID/MAC address pairing in the memory.

19. The remote authentication system of claim 18, wherein further instructions are stored in the memory, that when executed, cause the processor to:
in response to one of:
both of the charger loyalty parameter and the MAC address loyalty parameter being below respective threshold values;
one of the charger loyalty parameter and the MAC address loyalty parameter being below a respective threshold value, and a number of series of rolling MAC addresses plus a number of non-rolling MAC addresses being greater than a number of connectors of the charger; and
the MAC address being a rolling MAC address and the number of series of rolling MAC addresses per charger being greater than one;
perform a connector-level analysis of the charger ID/MAC address pairing to determine a correspondence between multiple MAC addresses of the charger and multiple connectors of the charger.

20. The remote authentication system of claim 19, wherein further instructions are stored in the memory, that when executed, cause the processor to:
during the connector-level analysis of the charger ID/MAC address pairing:
for each connector of the charger of the charger ID/MAC address pairing:
calculate a connector loyalty parameter of the connector, the connector loyalty parameter a number between 0 and 1 corresponding to a ratio of a number of charging sessions including a combination of the connector with the MAC address to a total number of charging sessions of the connector;
calculate a MAC address loyalty parameter of the connector, the MAC address loyalty parameter a number between 0 and 1 corresponding to a ratio of the number of charging sessions including a combination of the connector with the MAC address to a total number of charging sessions including the MAC address; and
in response to the MAC address not being a rolling MAC address and both of the connector loyalty parameter and the MAC address loyalty parameter being above respective threshold values, store a mapped connector/MAC address pairing in the memory.
